(19) United States
(12) Patent Application Publication
(10) Pub. No.: US 2021/0406958 A1
(43) Pub. Date: Dec. 30, 2021

(54) A VEHICLE PROMOTION SYSTEM FOR TARGETED ADVERTISING

(71) Applicant: GRABB-IT INC, A US COMPANY, MILPITAS, CA (US)

(72) Inventors: GAURAV GARG, MILPITAS, CA (US); WILLIAM STANISLAUS, FREMONT, CA (US); MAYUR MAHESHWARI, SALT LAKE CITY, UT (US)

(21) Appl. No.: 16/965,104

(22) PCT Filed: Dec. 3, 2018
(86) PCT No.: PCT/US2018/063548

§ 371 Date: Jul. 27, 2020

(30) Foreign Application Priority Data
Dec. 1, 2017 (IN) 201741043124

(51) Int. Cl. G06Q 30/02; G06F 3/14; H04M 1/72; G06K 7/14

(52) U.S. Cl. CPC G06Q 30/0265; G06K 7/1417; H04M 1/72; G06F 3/14

(57) ABSTRACT

A vehicle promotion system is disclosed for targeted advertisements including a discount coupon which can be scanned by a user device. The system includes a projection means in vehicle for displaying advertisements including a discount coupon and a personal cellular telecommunication device with a consumer module for scanning the discount coupon displayed in the window of the vehicle. The user with personal cellular telecommunication device having consumer module can either scan the code displayed in the window of the vehicle or shake their phone to scan the discount coupon if the vehicle is moving as shown in FIG. 1. The system includes a camera on the side windows of the vehicle to capture reactions of people.

### FIELD OF THE INVENTION

The present invention relates generally to vehicle promotion system and more particularly relates to vehicle promotion system for targeted advertising including a discount coupon which can be scanned by a user device.

### BACKGROUND

Discount coupons have long been distributed to consumers to promote the sale of goods or services. Typically, advertisers issue printed coupons which can be redeemed at a local retail outlet (or by mail) for a discount or refund upon making a purchase of goods identified by the coupon.

Advertisers issue printed coupons through merchandising such as direct mailing of advertising brochures or catalogs, printing advertisements or coupons in newspapers and magazines or, recently, through the internet. The customer collects the coupon and present it at the time of purchase to receive a discount, or brings the advertisement offering the discounted prices. The retail store redeems the coupon, which is typically bar coded to read by an optical scanner, or the computer system of the store will already be programmed with the discounted item price. While this method of promotion has proven to be effective, it has caused problems for manufacturers, consumers and merchants due to its massive inefficiency.

Advertisements are also commonly placed on moving vehicles such as buses, taxicabs, transit vehicles to allow more people to see an advertisement. Trucks with the sole purpose of serving as mobile billboards are becoming more common. By making the advertisement mobile, we can reach out for more people, as it can be delivered to areas that might otherwise be unreachable because of advertising restrictions or prohibitive costs.

Nowadays, dynamic advertising method using changeable displays is used. In addition, system for displaying targeted advertisements on windows of a moving or static vehicle are also emerging.

Hence, the present invention provides a vehicle promotion system for targeted advertising including a discount coupon which can be scanned by a user device.

### SUMMARY

An objective of the present invention is to provide a vehicle promotion system for targeted advertising including a discount coupon which can be scanned by a user device.

To achieve the above objective, the present invention provides a vehicle promotion system comprising a projection means in vehicle for displaying advertisements including a discount coupon and a personal cellular telecommunication device with a consumer module for scanning the discount coupon displayed on the window of the vehicle.

In accordance with the present invention, people commuting or walking on streets with their personal cellular telecommunication device having consumer module scans the code displayed on the window of the vehicle.

The system displays the targeted advertisements by determining the location of the vehicle based on multiple factors such as bid offered, distance of business from GPS location, surrounding businesses.

According to an embodiment, people can shake their personal cellular telecommunication device or open the consumer module and click to scan the discount coupon if the vehicle is moving.

In another embodiment, a camera is fixed on the side windows of the vehicle to capture the response of the people.

In yet another embodiment, a speaker is included on the side windows of the vehicle to deliver audio messages to the people.

In still another embodiment, a motion detector or a camera is fixed on the side windows of the vehicle to capture when people are moving nearby.

In still another embodiment, a Wi-Fi monitoring device is added to a processor, where system can identify electronic devices that are close to the vehicle for monitoring the proximity of the people near the vehicle involved for targeted advertising.

These objectives and advantages of the invention will become more evident from the following detailed description when taken in conjunction with the accompanying drawings.

### BRIEF DESCRIPTION OF THE DRAWINGS

FIG. 1 illustrates the overall process of the end user module

### DETAILED DESCRIPTION OF THE INVENTION

The present invention discloses a vehicle promotion system for targeted advertising on windows of a moving or static vehicle which can be scanned by a user device.

According to the present invention, the system comprises a projection means in vehicle for displaying advertisements including a discount coupon and a personal cellular telecommunication device with a consumer module for scanning the discount coupon displayed on the window of the vehicle.

In accordance with the present invention, people commuting or walking on streets with their personal cellular telecommunication device having consumer module scans the code displayed on the window of the vehicle.

With reference to the present invention, the personal cellular telecommunication device described herein includes but is not limited to a computer, smartphone, mobile phone, tablet or anything similar to it. The projection on the vehicles window is flexible i.e., it takes the vehicles windows shape and curve. Also, vehicle windows have thin film pasted with adhesive which acts as medium for displaying the content.

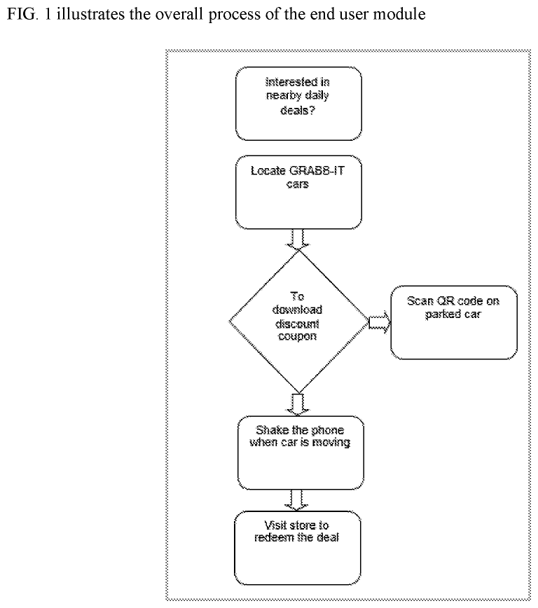

Referring to FIG. 1, the overall process of the end user module is illustrated. A user interested in nearby daily deals can locate the vehicle with advertisement display system where the window of the vehicle displays the advertisement with a code. The user can scan the code to collect the discount coupon if the vehicle is static. Once the discount coupon is scanned the user can visit a store to redeem the deal. Examples of vehicle of the present invention includes but is not limited to a car.

The code displayed in the vehicle can be a QR code or any other type of codes.

The system displays the targeted advertisements by determining the location of the vehicle based on multiple factors such as bid offered, distance of business from GPS location, surrounding businesses.

According to an embodiment, people can shake their personal cellular telecommunication device or open the consumer module and click a button to scan the discount coupon if the vehicle is moving.

In another embodiment, a camera is fixed on the side windows of the vehicle to capture reactions of the people. The reactions can be behaviour pattern of the people in different geolocations.

In yet another embodiment, a speaker is additionally fixed on the side windows of the vehicle to deliver audio messages to the people.

In still another embodiment, a motion detector or a camera is fixed on the side windows of the vehicle to capture people moving nearby.

In still another embodiment, a Wi-Fi monitoring device is added to processor, where system can identify electronic devices that are close to the vehicle for monitoring the proximity of the people near the vehicle involved for targeted advertising.

Further, the Wi-Fi monitoring system estimates people reach around an advertising car while the car is moving or stationary. Impression count/reach out is taken using the Wi-Fi monitoring system for nearby electronic devices (Preferably, smartphones)

Additionally, the Wi-Fi monitoring system includes one or more Wi-Fi chipset which are used to capture 802.11 packets on various channels and determine the number of smartphones i.e. Wi-Fi clients around the advertisement display screen. The 802.11 packets are captured preferably from smartphones with Wi-Fi client devices.

The 802.11 packets include management frame where probe request is done and control frames where request to send (RTS) and clear to send (CTS) is done.

Furthermore, two Wi-Fi chipsets on the hardware operates on the following specifications.

One chipset/radio is configured to operate on 2.4 GHz band with following channels 1, 3, 6, 9 and 11, which covers all the overlapping 20 MHz channels in this 2.4 GHz band.

Other chipset/radio is configured to operate on 5.0 GHz band with following channels 36, 38, 40, 42, 44, 46, 48, 50, 52, 54, 56, 58, 60, 62, 64, 100, 102, 104, 106, 108, 110, 112, 114, 116, 118, 120, 122, 124, 126, 128, 132, 134, 136, 138, 140, 142, 144, 149, 151, 153, 155, 157, 159, 161, 165.

Channel hoping on above bands are done every 250 milliseconds for scanning for Wi-Fi client devices. Once Wi-Fi client is discovered, entries are maintained as along as that client is seen within last 30 seconds. If the client is not seen in recent 30 seconds window, it is considered as timed out and removed from the database.

With reference to the present invention, the electronic devices referred herein includes computer, smartphone, mobile phone, tablet or anything similar.

Thus, the present invention is used in targeting audience to look into advertisements. This can be used by local shops where the local shops can advertise daily deals on all vehicles within some fixed radius. Also, big businesses can run immediate campaigns all over the places.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A vehicle promotion system for targeted advertisements, comprising:
a. a projection means in the vehicle for displaying targeted advertisements, the targeted advertisements include a discount coupon; and
b. a personal cellular telecommunication device with a consumer module for scanning the discount coupon.

2. The vehicle promotion system as claimed in claim 1, further comprises a camera on windows of the vehicle to capture reactions of the people.

3. The vehicle promotion system as claimed in claim 1, further includes a Wi-Fi monitoring system to estimate the people reach near a stationary or a moving advertising vehicle and to take impression count for nearby electronic devices.

4. The vehicle promotion system as claimed in claim 1, wherein the personal cellular telecommunication device is selected from any of a computer, smartphone, tablet or the like.

5. A vehicle promotion method for targeted advertisements, comprising:
a. displaying a code including discount coupon;
b. scanning the code by personal cellular telecommunication device; and
c. using the discount coupon for redeeming the product at retail store.

6. The method as claimed in claim 4, wherein the code is scanned by shaking the personal cellular telecommunication device while the vehicle is moving.
